(19) United States
(12) Patent Application Publication
(10) Pub. No.: US 2026/0041040 A1
(43) Pub. Date: Feb. 12, 2026

(54) Auger Pulse Smoothing for Preservative Application System in Baler

(71) Applicant: AGCO Corporation, Duluth, GA (US)

(72) Inventors: Cale Jared McCabe, Hesston, KS (US); Eric Wane Bolton, Buhler, KS (US)

(21) Appl. No.: 19/290,434

(22) Filed: Aug. 5, 2025

Related U.S. Application Data
(60) Provisional application No. 63/679,727, filed on Aug. 6, 2024.

(51) Int. Cl. A01F 15/08

(52) U.S. Cl. CPC A01F 15/0816

(57) ABSTRACT

A preservative additive applicator for an agricultural baler includes an auger distribution tube with a tube body having dispensing opening at a distal end and a proximal end, the auger distribution tube received at a housing mouth of the auger housing such that the proximal end is mounted adjacent the auger housing with the auger extending through the auger distribution tube to the distal end so as to direct the preservative additive from the auger housing toward the dispensing opening. The auger distribution tube has one or more cutouts positioned along a bottom portion of the auger distribution tube through which a portion of the preservative additive is dispensed from the auger distribution tube along a length of the tube body.

### CROSS-REFERENCE TO RELATED APPLICATION

This application claims the benefit of the filing date of U.S. Provisional Patent Application 63/679,727, “AUGER PULSE SMOOTHING FOR PRESERVATIVE APPLICATION SYSTEM IN BALER,” filed Aug. 6, 2024, the entire disclosure of which is incorporated herein by reference.

### BACKGROUND

### Field

This disclosure relates to a preservative additive dispensing system, and in particular to a preservative additive applicator for introducing dry preservative additives to crop being processed by an agricultural machine, such as a baler.

### Description of Related Art

Controlling the moisture level of cut crop, both within the cutting process such as with a swather or windrower and the baling process has a direct effect on the suitability of the cut crop material for an intended purpose. The care of hay, straw or other cut crop material is dependent on the moisture content. During the hay making process, sometimes the hay needs to be baled before it is completely dry. If the hay is baled with too much moisture it will become moldy and hot due to oxygen around it and bacteria decomposing the wet hay. Animals resist eating this type of poor-quality hay, and all is wasted. Below a moisture level of approximately 15%, cut crop material is considered to be “dry”. Generally, such cut crop material may be baled and stored without a preservative. “Semi-wet” crop material, with a moisture content between approximately 15% and 30%, typically requires the addition of a preservative during a baling process or should be wrapped in an air-tight fashion shortly after the bale is formed. There are additives that can be put onto wet hay that will preserve the hay and prevent spoilage of the crop material caused by mold and/or fungus. The additives are applied to the plant material by an additive dispensing applicator that introduces a dry particulate additive to the crop being processed by the baler.

The additive dispensing applicator typically uses an auger or screw conveyor as the metering device to apply the desired amount of additive to the crop material being processed by the baler. While there are different designs of dry hay preservative applicators currently on the market, they all typically have issues with the metering device not providing a constant flowrate of additive material. Instead, the additive material tends to pulse out of the conveyor making the flowrate resemble a sine wave instead of a desired constant rate. This causes an inconsistent coverage of the preservative throughout the hay bale. The pulsing effect coming out of an auger is caused by auger flighting holding material back like a gate until reaching the end of the dispensing tube, and then instantly dumping a large amount of the additive material held between the adjacent flights. The remaining material left between the two flights will slowly trickle out until the next flight comes by, repeating the process. Attempts have been made to minimize this problem by reducing the diameter of the dispensing tube and by increasing the rotational speed of the auger. However, the merely masks the problem by reducing the period of the pulse. Also, this solution limits the flowrates achievable by the auger metering system.

It is an advantage of the present invention that an improved preservative additive dispensing apparatus is provided.

### BRIEF SUMMARY

One aspect of the invention is directed to a baler having a pickup assembly for collecting plant material and directing the plant material to a baling chamber and a preservative additive applicator configured to add a preservative additive to the plant material. The preservative additive applicator includes a hopper configured to hold a supply of preservative additive, an auger housing in communication with the hopper, the auger housing having an auger mounted in the auger housing and rotatable such that auger flighting on the auger delivers preservative additive from the hopper through the auger housing. The auger is used to control the rate of dispensing the preservative additive from the preservative additive applicator. The preservative additive applicator includes an auger distribution tube with a tube body having dispensing opening at a distal end and a proximal end, the auger distribution tube received at a housing mouth of the auger housing such that the proximal end is mounted adjacent the auger housing with the auger extending through the auger distribution tube to the distal end so as to direct the preservative additive from the auger housing toward the dispensing opening. The auger distribution tube has one or more cutouts 402 positioned along a bottom portion of the auger distribution tube through which a portion of the preservative additive is dispensed from the auger distribution tube along a length of the tube body. In one aspect of the invention, the one or more cutouts form a non-uniform opening has changing widths along the lateral length of the tube body such that a position in the non-uniform opening closer to the proximal end has a smaller width than a position in the non-uniform opening closer to the distal end of the tube body.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiment.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates shows agricultural machine having a preservative additive applicator;

FIG. 2 shows an exploded isometric view of elements of the preservative additive applicator shown in FIG. 1;

FIG. 3 illustrates a sectional view of the preservative additive applicator of FIG. 2;

FIG. 4A illustrates one embodiment of an auger distribution tube of the preservative additive applicator;

FIG. 4B illustrates another embodiment of an auger distribution tube of the preservative additive applicator;

FIG. 4C illustrates another embodiment of an auger distribution tube of the preservative additive applicator; and

FIG. 4D illustrates another embodiment of an auger distribution tube of the preservative additive applicator;

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description. Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” are used as a matter of mere convenience and are determined by standing at the rear of the machine facing in its normal direction of travel. Furthermore, the various components shown or described herein for any specific application of this invention can be varied or altered as anticipated by this invention and the practice of a specific application of any clement may already by widely known or used in the art by persons skilled in the art and each will likewise not therefore be discussed in significant detail.

As used herein, the singular forms following “a,” “an,” and “the” are intended to include the plural forms as well, unless the context clearly indicates otherwise. As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded. As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

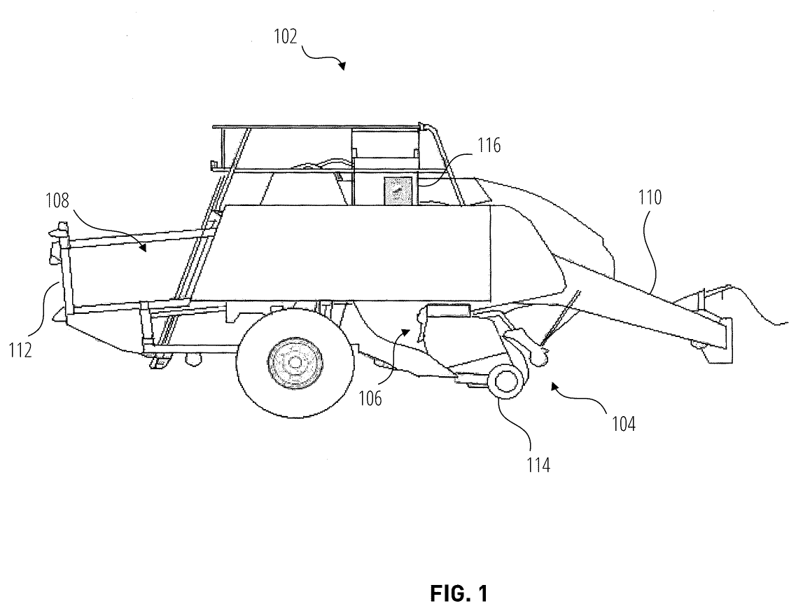

Referring to FIG. 1, an example agricultural baler 102 is shown into which embodiments of the present invention may be incorporated. Broadly, the baler 102 may be configured to move over a field and collect previously cut plant material and to compress, shape, and secure the collected plant material into a plurality of bales. The baler 102 may generally include a pickup assembly 104, stuffer assembly 106, and a baling (or compression) chamber 108 having a reciprocating plunger (not shown). Additionally, the baler 102 may be hitched to a towing vehicle (not shown) by a tongue 110, and power for operating the various mechanisms (e.g., the reciprocating plunger) of the baler 102 may be supplied by a power take-off of the towing vehicle. The baler 102 is depicted as an “in-line” type of baler wherein crop material is picked up below and slightly ahead of baling chamber 108 and then loaded up into the bottom of baling chamber in a straight-line path of travel. The finished bale may be ejected from a discharge end 112 of the baling chamber 108 and then dropped to land on the field behind the baler 102 for subsequent collection. The pickup assembly 104 is positioned under the tongue 110 on the longitudinal axis of the machine, somewhat forwardly of the baling chamber 108. The pickup assembly 104 has a pair of ground wheels 114 (one shown) that support the pickup assembly as the baler 102 advances along the ground.

A preservative additive applicator 116 is shown that may be installed on the baler 102. While the preservative additive applicator 116 is herein described with reference to a baler 102, one skilled in the art will understand that the baler 102 is an exemplary example of an agricultural machine that may use the preservative additive applicator 116, and the invention is not limited to a baler 102. The preservative additive applicator 116 is configured to add a preservative additive to the plant material added to the baling chamber 108 by the stuffer assembly 106.

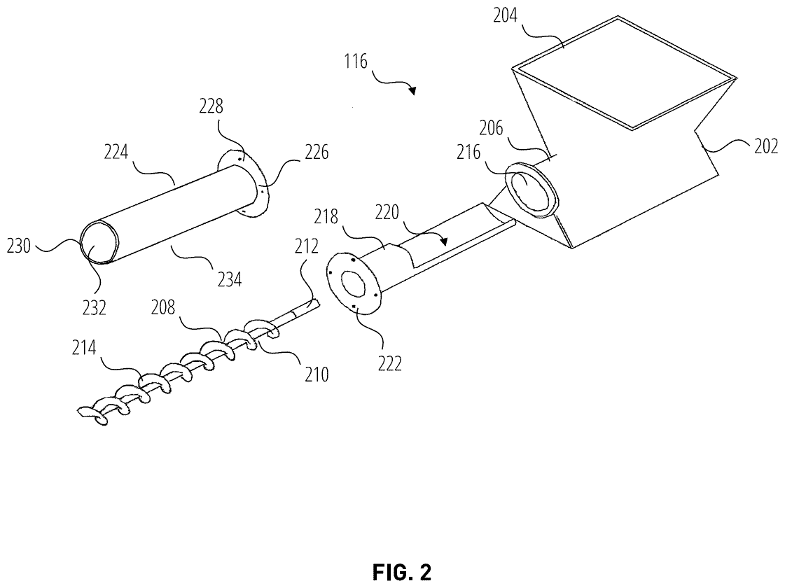

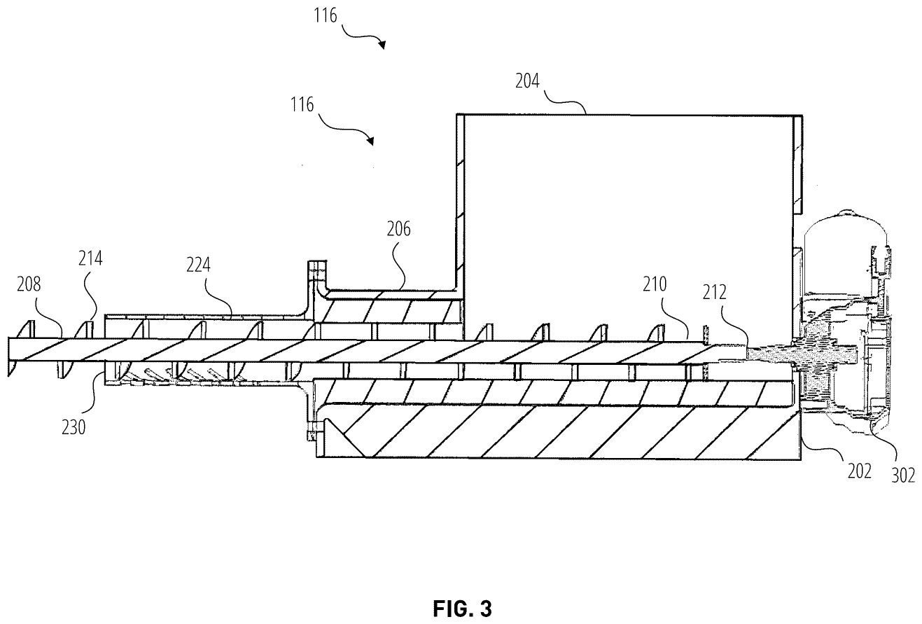

Referring also now to FIG. 2 and FIG. 3, the preservative additive applicator 116 includes a generally box-like applicator body 202 configured to allow the preservative additive applicator 116 to be mounted on the baler 102 of FIG. 1. A hopper 204 is located at an upper end of the applicator body 202. The hopper 204 is configured to hold a supply of additive and deliver the additive to an auger housing 206 in communication with the hopper 204. An auger 208 is mounted in the auger housing 206 and configured to control a rate of additive taken from the hopper and dispensed by the preservative additive applicator 116 as will be described below. As would be understood by one skilled in the art, a shank 210 of the auger 208 is connected to a motor 302 at tang 212 such that as the auger 208 is rotated by the motor 302, auger flighting 214 on the auger 208 carry the additive from the hopper 204 to a housing mouth 216 of the auger housing 206. In one embodiment, the auger housing 206 may receive an internal sleeve 218 having a feed opening 220 in alignment with the hopper 204 and a bore 222 through which the auger 208 carries the additive to the housing mouth 216.

An auger distribution tube 224 is received at a housing mouth 216 of the auger housing 206 such that a proximal end 226 of the auger distribution tube 224 is mounted to the auger housing 206 such as with mounting flange 228 and suitable fasteners (not shown). As best seen in FIG. 3, the auger 208 extends through the auger distribution tube 224 to a distal end 230 so as to direct the additive from the housing mouth 216 of the auger housing 206 toward a dispensing opening 232 at a distal end 230 of the auger distribution tube 224. From the dispensing opening 232, the preservative additive applicator 116 dispenses the additive to the plant material being baled by the baler 102. The auger 208 is used as the metering device for controlling the rate of additive dispensed from the preservative additive applicator 116.

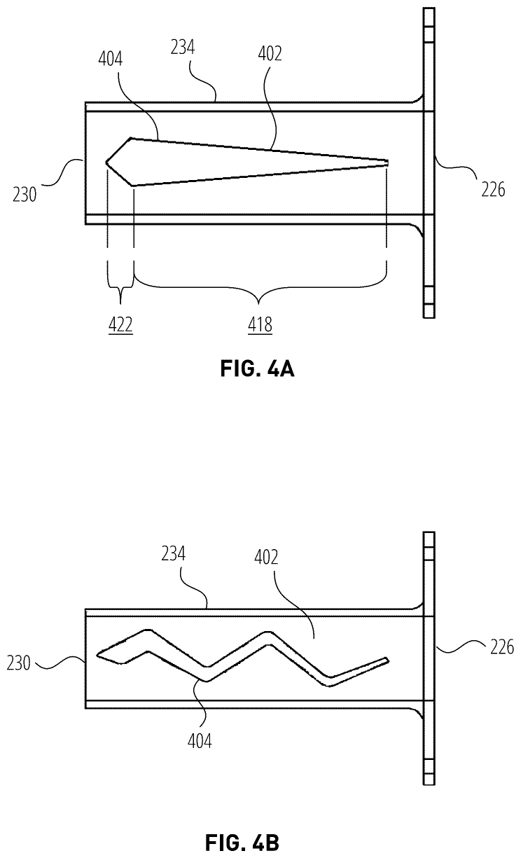

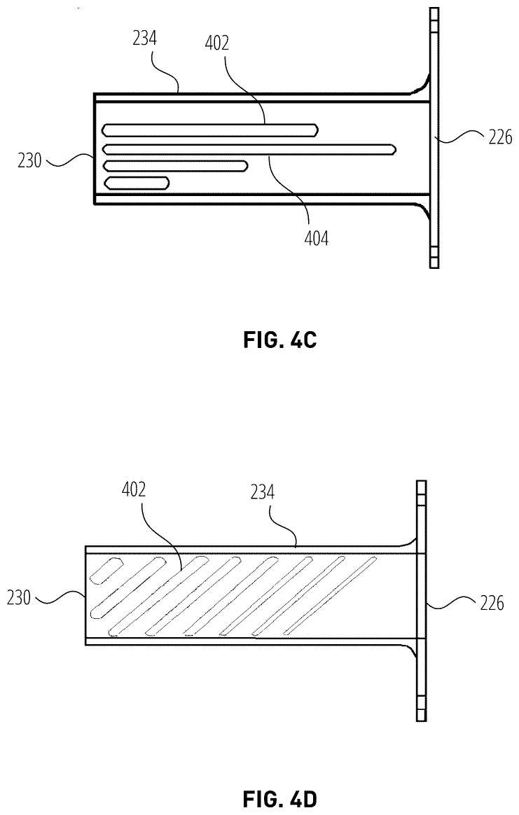

Turning now to FIGS. 4A-4D, the auger distribution tube 224 has one or more cutouts 402 positioned along a bottom portion of the auger distribution tube 224 through which the additive may be dispensed from the auger distribution tube 224 in addition to the dispensing opening 232 at the distal end 230 of the auger distribution tube 224. The cutouts 402 allow a portion of the additive to be dispersed along a length of the tube body 234 while limiting the flowrate of the additive carried through to tube body 234 that exits the auger distribution tube 224 at the dispensing opening 232 by slowing down the initial discharge and spreading it out over both time and along the linear length of the auger distribution tube 224. Desirably, the cutouts 402 do not cause the additive to be held back in the tube body 234 which would cause the auger 208 to clog. Desirably, the cutouts 402 do not affect the total flowrate of additive from the preservative additive applicator 116; the speed of the auger 208 still determines the overall flowrate of additive from the preservative additive applicator 116. The cutouts 402 in the bottom of the tube body 234 simply smooth out the inconsistencies by discharging additive from multiple sections of auger flighting 214 at once, thus minimizing the gating effect mentioned above.

As shown in FIGS. 4A-4D, various cutout 402 designs may be used to reduce the pulsing effect different size additive products and different flowrates. In an embodiment shown in FIG. 4A, there is a single cutout 402 with the cutout 402 having a non-uniform opening 404 along a lateral length of the tube body 234. In this embodiment, the non-uniform opening 404 has changing width along the lateral length of the tube body 234 such that in at least a first portion of opening 406 a position closer to the proximal end 226 has a smaller width than a position closer to the distal end 230 of the tube body. The cutout 402 may have a symmetrical expanding shape for the non-uniform opening 404 as shown in FIG. 4A, or the non-uniform opening 404 may have a pattern such as a sawtooth pattern as shown in the FIG. 4B. FIGS. 4C and 4D illustrate embodiments where the non-uniform opening 404 has a plurality of individual openings configured such that the combination of the openings produce the non-uniform opening 404 such that a position closer to the proximal end 226 has a smaller opening width than a position closer to the distal end 230 of the tube body 234. The non-uniform openings 404 may be in a pattern of openings with progressively larger widths as shown in the embodiment of FIG. 4D, or the non-uniform openings 404 may have different initiation points along the lateral length of the tube body 234 as shown in FIG. 4C to achieve the progressively larger non-uniform opening 404 width. To avoid doubt, one skilled in the art will understand that progressively larger opening width means that the auger distribution tube 224 is configured with one or more openings 404 that predominantly have progressively larger opening sizes from the proximal end 226 to the distal end 230 such that the progressively larger opening width of a first portion of opening 406 is substantially met while still allowing for the possibility of patterns that may produce small irregularities where small areas along the lateral length, e.g., less than 15%, and more desirably less than 10%, of the lateral length, may have larger widths than areas closer to the distal end 230 of the tube body 234 as shown by second portion of opening 408 as shown in FIG. 4A.

When the size and pattern of cutouts 402 are suitably configured, the pulsing effect of the dispensed additive is reduced, resulting in a more constant flowrate as determined by the rotational speed of the auger 208. The patterns of the cutouts 402 may be customized to a wide variety of shapes and orientations to accomplish different tasks by selecting the geometry of the non-uniform opening 404 to address different particle sizes or different flowrates.

Having cutouts 402 with the non-uniform opening 404 with a smaller opening area closer to the proximal end 226 and growing to a larger opening area closer to the distal end 230 delivers a more constant rate of discharge from the auger distribution tube 224. This desirably leads to more consistent coverage of the preservative throughout the hay bale. These cutouts 402 limit the flowrate that material exits the auger 208 by slowing down the initial discharge and spreading it out over both time and along the linear length of the auger distribution tube 224 while not holding preservative additive back causing the auger to clog and not affecting the flowrate of additive material, as the speed and diameter of the auger 208 still determine the overall flowrate.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. A baler having a pickup assembly for collecting plant material and directing the plant material to a baling chamber and a preservative additive applicator configured to add a preservative additive to the plant material, the preservative additive applicator comprising:
a hopper configured to hold a supply of preservative additive;
an auger housing in communication with the hopper, the auger housing having an auger mounted in the auger housing and rotatable such that auger flighting on the auger delivers preservative additive from the hopper through the auger housing, the auger used to control a rate of dispensing the preservative additive from the preservative additive applicator;
an auger distribution tube with a tube body having dispensing opening at a distal end and a proximal end, the auger distribution tube received at a housing mouth of the auger housing such that the proximal end is mounted adjacent the auger housing with the auger extending through the auger distribution tube to the distal end so as to direct the preservative additive from the auger housing toward the dispensing opening, wherein the auger distribution tube has at least one cutout positioned along a bottom portion of the auger distribution tube through which a portion of the preservative additive is dispensed from the auger distribution tube along a lateral length of the tube body.

2. The baler of claim 1 wherein the cutouts cause the auger distribution tube to discharge preservative additive from multiple sections of the auger flighting at once to spread out distribution of the preservative additive.

3. The baler of claim 1 wherein the at least one cutout comprises a single cutout with the cutout having a non-uniform opening along the length of the tube body.

4. The baler of claim 3 wherein the non-uniform opening has changing widths along the lateral length of the tube body such that a position in the non-uniform opening closer to the proximal end has a smaller width than a position in the non-uniform opening closer to the distal end of the tube body.

5. The baler of claim 1 wherein the at least one cutout comprises a plurality of cutouts such that a combination of the plurality of cutouts produce a non-uniform opening such that a position in the non-uniform opening closer to the proximal end has a smaller opening width than a position in the non-uniform opening closer to the distal end of the tube body.

6. The baler of claim 5 wherein the non-uniform opening is in a pattern of openings with progressively larger widths.

7. The baler of claim 5 wherein the non-uniform opening is formed with cutouts that have different initiation points along the lateral length of the tube body to achieve the progressively larger width of the non-uniform opening.
